(19) United States
(12) Patent Application Publication
(10) Pub. No.: US 2026/0111049 A1
(43) Pub. Date: Apr. 23, 2026

(54) VOLTAGE LIMITER FOR A VOLTAGE REGULATOR

(71) Applicant: NXP B.V., Eindhoven (NL)

(72) Inventors: Ids Christiaan Keekstra, Nieuw-Amsterdam (NL); Jos Verlinden, Wachtendonk (NL); Marco Lammers, Neerkant (NL)

(21) Appl. No.: 18/918,295

(22) Filed: Oct. 17, 2024

(51) Int. Cl. G05F 1/571; G05F 1/575

(52) U.S. Cl. CPC G05F 1/571; G05F 1/575

(57) ABSTRACT

A voltage limiter for a voltage regulator includes two comparison paths, each with a transistor. One comparison path is coupled to a reference voltage, the other is coupled to the regulator output. The limiter includes a resistor in a path between the control terminals of the two transistors to provide a voltage drop in response to current flowing through the resistor. The second comparison path includes a trigger node whose voltage controls the conductivity of a shunt transistor for shunting current from the regulator output. The voltage limiter includes a current control circuit for controlling a current through the resistor to generate the voltage drop across the resistor, wherein the current control circuit adjusts the current through the resistor to control the voltage drop based on a voltage of the trigger node.

### BACKGROUND OF THE INVENTION

### Field of the Invention

This invention relates to voltage regulators with voltage limiters.

### Background

Voltage regulators are used to provide a regulated voltage for electronic systems. Voltage limiters are utilized to prevent or minimize an overvoltage condition of the regulated voltage that may occur for example, during a load changing condition.

### BRIEF DESCRIPTION OF THE DRAWINGS

The present invention may be better understood, and its numerous objects, features, and advantages made apparent to those skilled in the art by referencing the accompanying drawings.

FIG. 1 is a circuit diagram of a prior art voltage regulator.

FIG. 2 is a timing diagram of an operation of the circuit of FIG. 1.

FIG. 3 is a circuit diagram of a prior art voltage regulator with a voltage limiter.

FIG. 4 is a timing diagram of an operation of the circuit of FIG. 4.

FIG. 5 is circuit diagram of a voltage regulator with a voltage limiter according to one embodiment of the present invention.

FIG. 6 is a timing diagram of an operation of the voltage regulator of FIG. 5 according to one embodiment of the present invention.

The use of the same reference symbols in different drawings indicates identical items unless otherwise noted. The Figures are not necessarily drawn to scale.

### DETAILED DESCRIPTION

The following sets forth a detailed description of a mode for carrying out the invention. The description is intended to be illustrative of the invention and should not be taken to be limiting.

As disclosed herein, a voltage limiter for a voltage regulator includes two comparison paths, each with a transistor. One comparison path is coupled to a reference voltage, the other is coupled to the regulator output. The limiter includes a resistor in a path between the control terminals of the two transistors to provide a voltage drop in response to current flowing through the resistor. The second comparison path includes a trigger node whose voltage controls the conductivity of a shunt transistor for shunting current from the regulator output. The voltage limiter includes a current control circuit for controlling a current through the resistor to generate the voltage drop across the resistor, wherein the current control circuit adjusts the current through the resistor to control the voltage drop based on a voltage of the trigger node.

Providing a limiter circuit with a current control circuit that adjusts current though a resistor located between the control terminals of the two transistors in the two comparison paths to control a voltage drop across the resistor based on the voltage of a trigger node of one of the paths may advantageously allow for the voltage drop between the two control terminals to be adjusted to bias the trigger node at a voltage that will enable a faster shunting of current from the regulator output in response to rapidly changing load conditions.

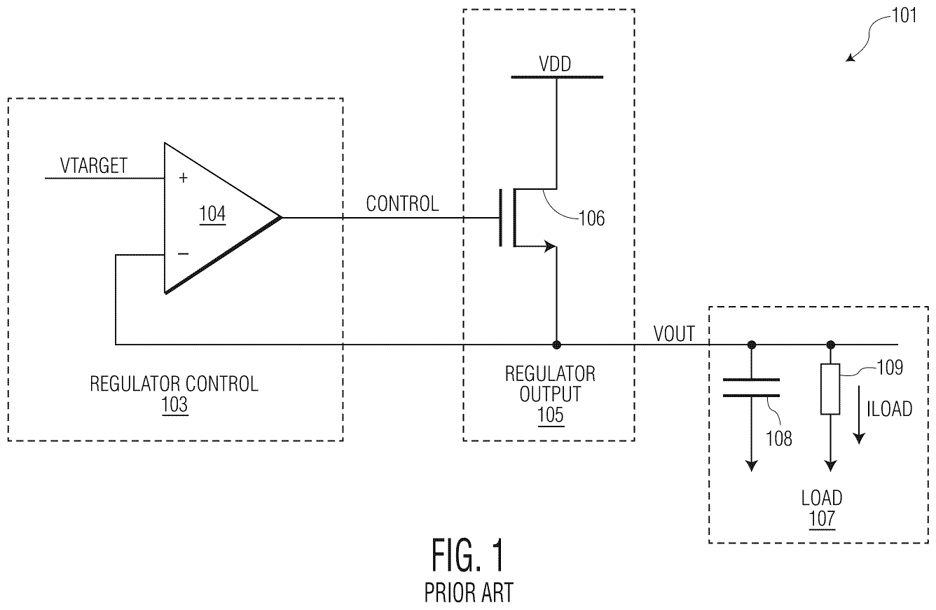

FIG. 1 is a circuit diagram of a prior art voltage regulator 101. Regulator 101 includes a regulator control circuit 103 and a regulator output circuit 105. Output circuit 105 includes an NFET 106 having drain connected to a supply voltage terminal VDD and a source connected to the regulator output VOUT that provides a regulated voltage to a load 107, which is represented in FIG. 1 as a load resistor 109 and a load capacitor 108. ILOAD represents the current drawn from the voltage regulator by the load during operation.

The gate of NFET 106 is controlled by a CONTROL signal produced by control circuit 103. The control circuit 103 includes a buffer circuit 104 configured with a feedback control loop that drives the CONTROL signal such that the voltage of VOUT matches the reference voltage VTARGET.

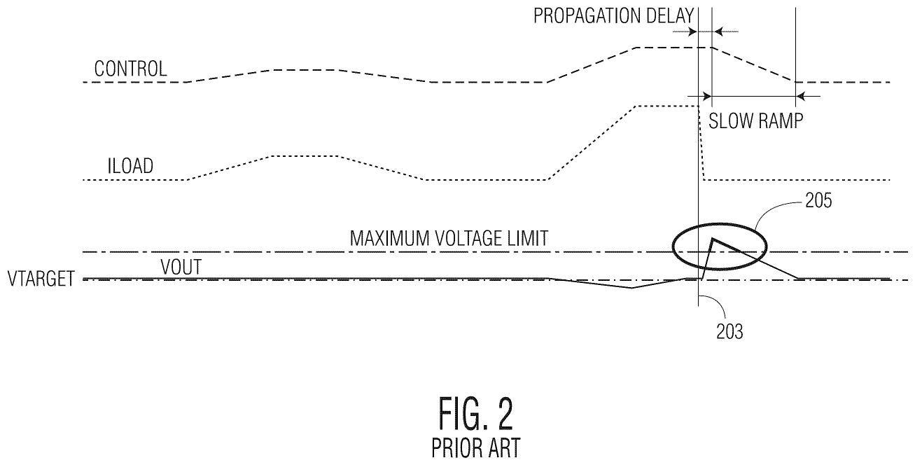

FIG. 2 is a timing diagram showing the voltage of the CONTROL signal, the load current ILOAD, and the voltage of VOUT during an operation of regulator 101. As shown in FIG. 2, the voltage of the CONTROL signal increases and decreases in response to increasing and decreasing load conditions, as shown by changes in the load current ILOAD such that the voltage of VOUT tracks VTARGET. When the change in load conditions is small (as shown by the smaller slope of ILOAD in FIG. 2), the control circuit 103 is able to drive the CONTROL signal such that the voltage of VOUT is relatively constant at VTARGET.

However, as the load conditions increase and decrease more rapidly, the control circuit is not fast enough to respond to the changes in load current ILOAD and the voltage of VOUT begins to deviate from the voltage set by VTARGET. FIG. 2 shows a “worst-case” condition where the load at time 203 falls abruptly from a high load condition to a low load condition, such as during a change in power mode or during an unexpected shut down condition. As shown in FIG. 2, control circuit 103 is slow to respond in changing the CONTROL signal to match the change in load current. Specifically at time 203, there is a propagation delay and then a slow ramp down of the CONTROL signal in response to the sudden decrease in load current ILOAD. Because the CONTROL signal is slow to respond to the sudden decrease in load current, NFET 106 is more conductive than it should be at this time and the voltage of VOUT quickly overshoots the MAXIMUM VOLTAGE LIMIT of load 107, which can cause reliability problems. In some instances, the voltage overshoot may damage the circuitry of load 107. As an example, the overshoot voltage may exceed the safe operating areas of the transistors of load 107.

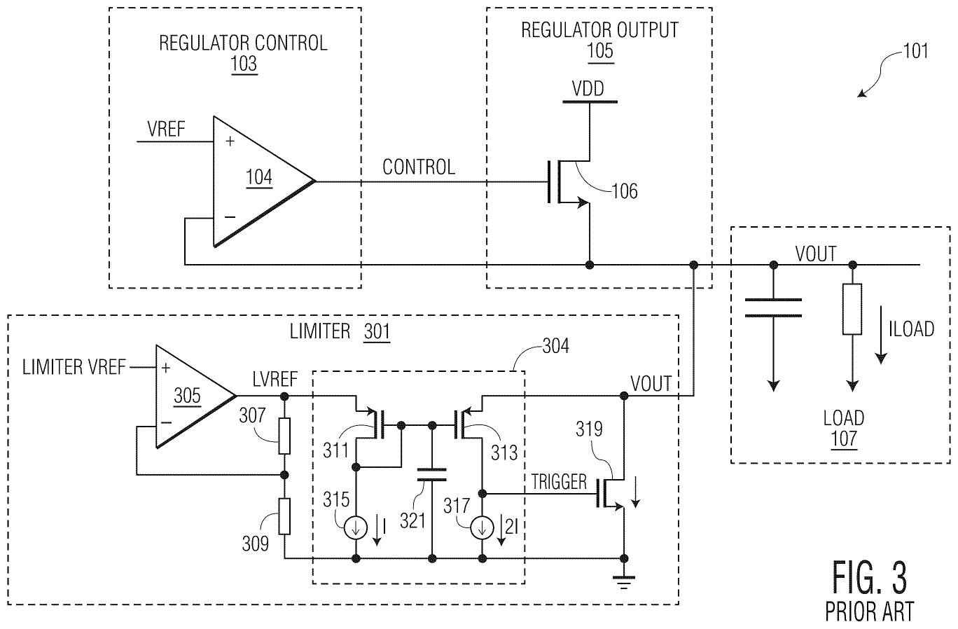

FIG. 3 is a circuit diagram of a prior art voltage regulator with a voltage limiter circuit 301. The items with the same reference numbers in FIG. 1 are similar. A voltage limiter circuit 301 is used to suppress a voltage overshoot condition of VOUT.

Limiter circuit 301 include a reference buffer 305 in a feedback loop configuration to provide an internal reference voltage LVREF that is set by the voltage LIMITER VREF and the ratio of resistors 307 and 309 in the feedback loop configuration. Limiter circuit 301 includes a trigger circuit 304 that produces a TRIGGER signal to make NFET 319 conductive to shunt regulator current from VOUT to ground to reduce the voltage of VOUT during an overshoot condition.

Trigger circuit 304 includes two current comparison paths. One path include PFET 311 and current source 315 and the other path includes PFET 313 and current source 317. In FIG. 3, current source 317 provides twice the amount of current (2I) as provided by current source 315 to provide a positive offset relative to LVREF (used in case where LVREF is equal to VTARGET). Trigger circuit 304 also includes a capacitor for smoothing momentary fluctuations to the voltage of the gates of PFETs 311 and 313 that may be caused by a sudden increase of VOUT.

The conductivity of PFET 313 is set by the by gate voltage of PFET 311 and VOUT. When VOUT is equal to or less than LVREF, trigger circuit 304 is configured such that the TRIGGER signal is nonasserted and NFET 319 is nonconductive. When VOUT rises above LVREF, the source-gate voltage of PFET 313 increases to make PFET 313 more conducive to pull the voltage of the TRIGGER signal above the threshold voltage of NFET 319 where NFET 319 begins to conduct to shunt current to reduce the voltage of VOUT. As long as VOUT is above LVREF, NFET 319 is conductive.

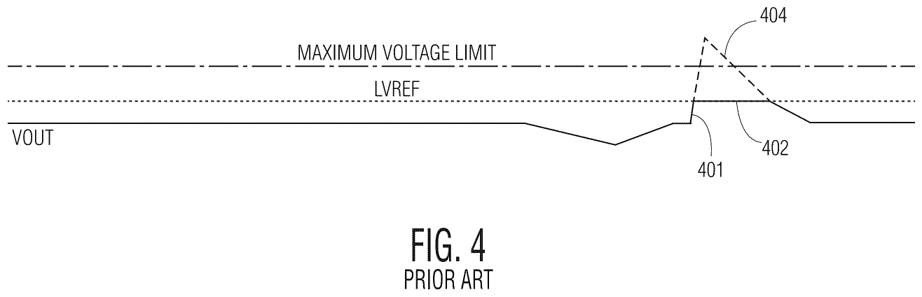

FIG. 4 shows an idealized timing diagram of the operation of the voltage regulator of FIG. 3. When VOUT is below or equal to LVREF, the TRIGGER signal is nonasserted and NFET 319 is nonconductive. However, once VOUT exceeds LVREF, then NFET 319 becomes conductive to limit the voltage as shown by line 402 to be equal to LVREF.

As stated above, FIG. 4 is an idealized timing diagram. In some instances of a rapidly changing load current ILOAD, trigger circuit 304 may not turn on NFET 319 fast enough to prevent VOUT from exceeding the MAXIMUM VOLTAGE LIMIT (as shown by dashed line 404). For example, if regulator 101 is in a high load current condition where the CONTROL signal is high and/or VOUT drops below VTARGET (as shown right before time 203 in FIG. 2), the conductivity of PFET 313 will be at an even lower condition than at equilibrium (when VOUT=LVREF) and the voltage of the TRIGGER signal will be at 0 volts. From this condition, a sudden decrease in load current (as at time 203 in FIG. 2), will require the source-gate voltage of PFET to quickly change from where PFET 313 is in a low conductivity condition to a higher source-gate voltage where PFET 313 is in a higher conductivity condition to pull the TRIGGER signal voltage from 0 V to above the threshold voltage of NFET 319 for NFET 319 to conduct. This causes an additional delay time for limiter circuit 301 to begin to shunt current from VOUT, which may allow for VOUT to exceed the safe operating voltage limit of the transistors of load 107.

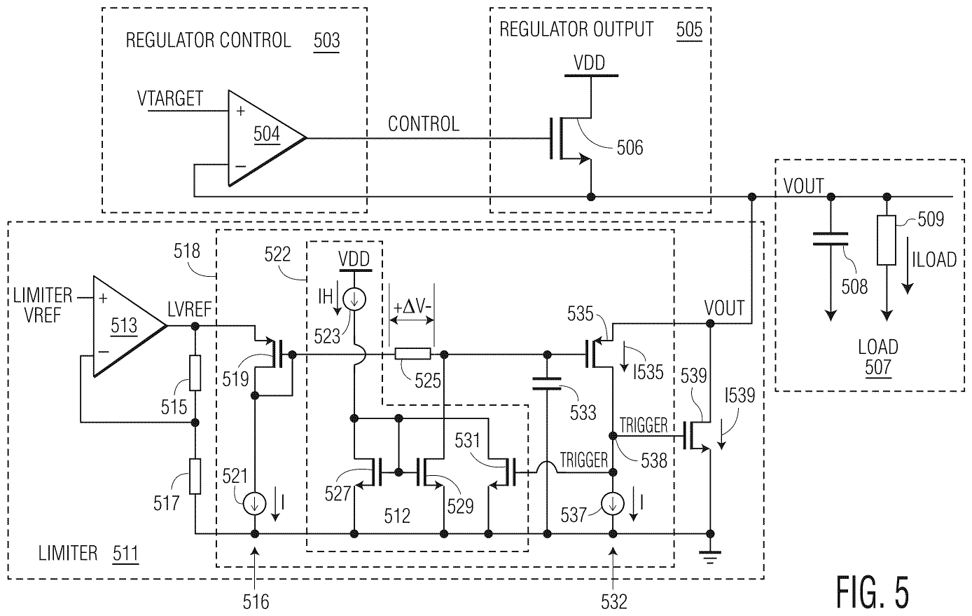

FIG. 5 shows a circuit diagram of a voltage regulator 501 according to one embodiment of the present invention. Regulator 501 includes a regulator control circuit 503 and a regulator output circuit 505 arranged in a linear regulator configuration. Output circuit 505 includes an NFET 506 having drain connected to a supply voltage terminal VDD and a source connected to the regulator output VOUT that provides a regulated voltage to a load 507, which is represented in FIG. 5 as a load resistor 509 and a load capacitor 508. ILOAD represents the current drawn from the regulator by the load during operation. Regulator 501 can be used to provide a regulated voltage to an electronic system in any one of a number of applications such as e.g., communication, automotive, industrial control, appliances, security and encryption, and data processing.

The gate of NFET 506 is controlled by a CONTROL signal produced by control circuit 503. Control circuit 503 includes a buffer 504 with a feedback control loop where the feedback signal is connected to the inverting input of buffer 504 and the reference voltage VTARGET is supplied to the noninverting input of buffer 504. The output of buffer 504 drives the CONTROL signal such that the voltage of VOUT is configured to match to the reference voltage VTARGET.

Regulator 501 includes a voltage limiter circuit 511 that is used to suppress a voltage overshoot condition of VOUT. Limiter circuit 511 includes a reference buffer 513 in a feedback configuration where its noninverting input is connected to a reference voltage LIMITER VREF and its inverting input is connected to a node between resistors 515 and 517. The output of buffer 513 provides an internal limiter reference voltage LVREF that is set by voltage LIMITER VREF and the ratio of resistors 515 and 517 in the feedback loop configuration. Limiter circuit 511 includes a trigger circuit 518 that produces a TRIGGER signal at trigger node 538 that is supplied to the gate of NFET 539 that makes NFET 539 conductive to shunt current from VOUT to voltage supply ground rail 512 to reduce the voltage of VOUT during a voltage overshoot condition.

Trigger circuit 511 includes two comparison paths. Path 516 includes PFET 519 and current source 521. The source of PFET 519 is connected to the output of buffer 513 to receive LVREF. The gate and drain of PFET 519 are connected to a terminal of current source 521. The other terminal of current source 521 is connected to ground rail 512, which is coupled to a ground voltage supply terminal. Path 532 includes PFET 535, trigger node 538, and current source 537. The source of PFET 535 is connected to VOUT and the drain is connected to trigger node 538. One terminal of current source 537 is connected to trigger node 538 and the other terminal is connected to ground rail 512. In FIG. 5, current source 521 provides the same current (I) as provided by current source 537. However, in other embodiments, the currents provided by current sources 521 and 537 may be different.

Trigger circuit 518 includes a capacitor 533 and a resistor 525, each with a terminal connected to the gate of PFET 535. The other terminal of resistor 525 is connected to the gate and drain of PFET 519. The other terminal of capacitor 533 is connected to ground rail 512.

Trigger circuit 511 includes a current control circuit 522 that includes a current source 523, NFET 531, and NFETs 527 and 529 configured in a current mirror configuration. Current source 523 is connected to the drains of NFETs 527 and 531 and to the gates of NFETs 527 and 529. Current source 523 is configured to provide a current of IH. The drain of NFET 529 is connected to resistor 525. In the embodiment shown, the mirror ratio of NFETs 527 and 529 is 1:1, but could be of other values in other embodiments. The drain of NFET 531 is connected to current source 523 and to the gates of NFETs 527 and 529. The gate of NFET 531 is connected to trigger node 538 to receive the TRIGGER signal. The source of NFET 531 is connected to ground rail 512.

When NFET 531 is nonconductive, circuit 522 produces a mirrored current of IH through the path of resistor 525 and NFET 529 to generate a voltage drop ΔV across resistor 525, which generates a voltage differential between the gate of PFET 519 and the gate of PFET 535. In some embodiments in this condition, ΔV is equal to current IH times the resistance of resistor 525, which represents the maximum value of ΔV (ΔVmax=IH*R525) during the operation of limiter circuit 511. However, ΔVmax may be of other values in other embodiments.

When NFET 531 is conductive, current from current source 523 flows through NFET 531. This lowers the voltage on the gate of NFET 529 to reduce the amount of current flowing through resistor 525 and NFET 529 to reduce ΔV from its maximum value (ΔVmax=IH*R525) to a lower voltage that dependent upon the conductivity of NFET 531 as controlled by the voltage of node 538. If NFET 531 is fully conductive, then ΔV is reduced to zero volts in some embodiments. Accordingly, NFET 531 acts to reduce ΔV when the TRIGGER circuit is asserted.

Reference voltage LVREF is set above VTARGET but below the MAXIMUM VOLTAGE LIMIT of load 507. For example, in one embodiment where VTARGET is 3.3 volts, LVREF is 3.7 volts, and the MAXIMUM VOLTAGE LIMIT is 3.9 volts, but these voltages may be of other values in other embodiments. When the voltage of VOUT exceeds LVREF, limiter circuit 511 acts to assert the TRIGGER signal to make NFET 539 conductive to shunt current from VOUT to ground rail 512 to reduce the voltage of VOUT so that it does not exceed the MAXIMUM VOLTAGE LIMIT.

The operation of limiter circuit 511 will be described with respect to three different voltage ranges of the voltage of VOUT. The first voltage range is where the voltage of VOUT is below or equal to LVREF−ΔVmax, (VOUT≤LVREF−ΔVmax). The second voltage range is where the voltage of VOUT is at a voltage above LVREF−ΔVmax but is below or equal to LVREF, (LVREF−ΔVmax<VOUT≤LVREF). And third voltage range is where the voltage of VOUT is above LVREF, (VOUT>LVREF).

For the first range where the voltage of VOUT is less than or equal to LVREF−ΔVmax, current IH is being drawn through resistor 525 and NFET 529 such that ΔV is at ΔVmax. With ΔV at ΔVmax, the voltage of the gate of PFET 535 is ΔVmax volts lower than the gate of PFET 519. Because VOUT is at a voltage lower than LVREF−ΔVmax, PFET 535 will not be at a sufficient conductivity level to pull the TRIGGER signal to an asserted voltage. Thus, no current is being shunted through NFET 539 from VOUT, and NFET 531 is nonconductive such at ΔV at ΔVmax.

When operating in the second voltage range (LVREF−ΔVmax<VOUT≤LVREF), the closed feedback loop of NFET 531 and NFET 529 is configured to adjust ΔV to control the conductivity of PFET 535 to adjust the voltage of trigger node 538 (the TRIGGER signal) such that NFET 531 (and therefore NFET 539) are on the edge of triggering. As used herein, a transistor on the edge of triggering is when it is on the edge of a transition from a quiescent state of low conductivity to an on state of high conductivity. The operation of the closed feedback loop works as follows. When the voltage of VOUT rises above LVREF−ΔVmax to operate in the second voltage range, the increased gate source-voltage of PFET 535 increases its conductivity to raise the voltage of the trigger node 538 to assert the TRIGGER signal, which causes NFET 539 to be conductive to shunt current from VOUT to ground rail 512. The TRIGGER signal being asserted also causes NFET 531 to become conductive to lower the voltage of the gate NFET 529 to reduce the current of through resistor 525, which lowers ΔV, which raises the gate voltage of PFET 535. The increase in gate voltage of PFET 535 makes PFET 535 less conductive to reduce the voltage of the TRIGGER signal to reduce the conductivity of NFET 539 and reduce the conductivity of NFET 531. Reducing the conductivity of NFET 531 increases the current through resistor 525 to increase to increase ΔV, which increases the conductivity of PFET 535, to raise the voltage of the TRIGGER signal, and so on to where (in a steady state or slow varying condition of VOUT) the closed feedback loop adjusts the voltage of the TRIGGER signal to where NFET 539 is on the edge of triggering (but not fully triggered). When the voltage of VOUT changes relatively slowly, only a quiescent amount of current flows through both NFET 539 and NFET 531 in this voltage range due to the TRIGGER signal being at a voltage above 0 volts where NFET 539 is on the edge of triggering.

Accordingly, when operating in this second voltage range, biasing the gate of PFET 535 at a voltage such that NFET 539 is on the edge of triggering can provide for a faster reacting current limiter circuit than with prior art circuits such as in FIG. 3. With the circuit of FIG. 5, when VOUT increases quickly due to a sudden decrease in load, the conductivity of PFET 535 does not have to increase significantly nor does the voltage of the TRIGGER signal have to rise all the way from zero volts to make NFET 539 fully conductive to shunt current from VOUT. Instead, the conductivity of PFET 535 and the voltage of the TRIGGER signal only have to increase slightly for the TRIGGER signal to make NFET 539 fully conductive to shunt current. Accordingly, limiter circuit 511 can react more quickly to reduce VOUT in an overvoltage condition in order to prevent damage to the circuitry of load 507.

Resistor 525 and capacitor 533 form a low pass filter that prevents sudden changes to the voltage of the gate of PFET 535. When operating in the second voltage range (LVREF−ΔVmax<VOUT≤LVREF), this low pass filter prevents the closed feedback loop of NFETs 531 and 529 from quickly reducing the conductivity of PFET 535 due to NFET 531 becoming conductive from the assertion of the TRIGGER signal. Thus, if VOUT were to rise quickly causing the TRIGGER signal to become assertive, the voltage at the gate of PFET 535 would not rise as quickly, thereby allowing PFET 535 to remain conductive momentarily to fully assert the TRIGGER signal instead of reducing the voltage of the trigger signal to where NFET 539 is on the edge of triggering. Accordingly, circuit 518 will be able to shunt more current following a sharp increase in VOUT when operating in the second voltage range.

When operating in the third voltage range (VOUT>LVREF), the gate-source voltage of PFET 535 is above a value such that the TRIGGER signal is fully asserted even though NFET 531 is fully conductive such and ΔV is at zero volts (or at another minimum value). At this condition, NFET 539 is fully conductive to shunt current to ground rail 512 to lower the voltage of VOUT to prevent damage to the circuitry of load 507.

In some embodiments, if a sudden increase in the voltage of VOUT of sufficient severity occurs while limiter circuit 511 is operating in the second voltage range (LVREF−ΔVmax<VOUT≤LVREF), the low pass filter of resistor 525 and capacitor 533 would keep the TRIGGER signal at a fully asserted level until limiter circuit 511 transitions to the third voltage range where the conductivity of NFET 531 would have no effect on the voltage of the TRIGGER signal. Accordingly, circuit 511 would be able to maintain its quick response to an overvoltage condition while the circuit transitions from the second voltage range to the third voltage range.

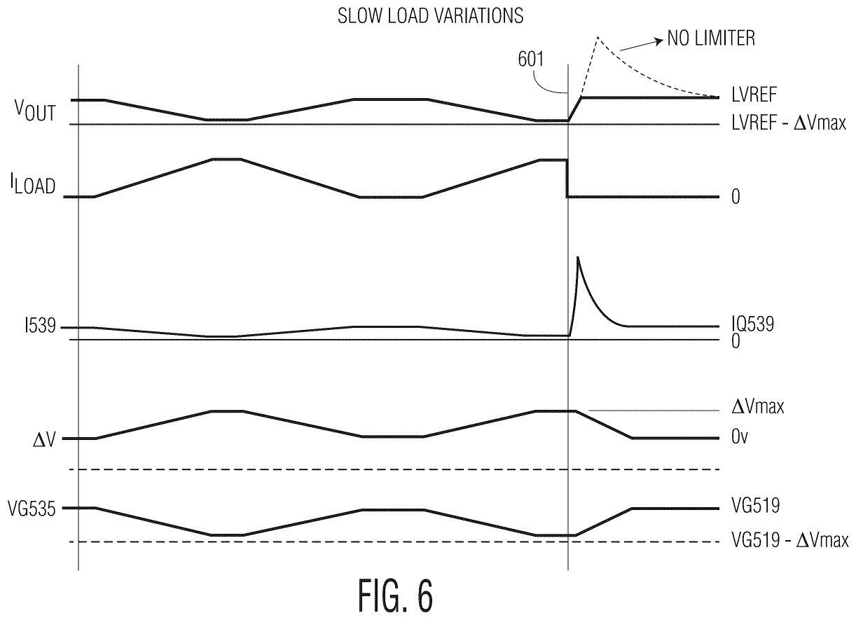

FIG. 6 is a timing diagram of operations of regulator 501 according to one embodiment. Shown in FIG. 6 are the voltage of VOUT, the load current (ILOAD), the shunt current through NFET 539 (I539), the voltage ΔV, and the gate voltage of PFET 535 (VG535). VG519 is the gate voltage of PFET 519, which is set by LVREF and the current of current source 521 (as shown in FIG. 5). FIG. 6 shows regulator 501 operating during a time period where the load current ILOAD changes relatively slowly (as indicated by SLOW LOAD VARIATIONS in FIG. 6) followed by a sudden change at time 601 where the load current ILOAD drops almost instantaneously and VOUT rises quickly.

During the time of slow load variations, regulator 501 operates in the voltage range of LVREF−ΔVmax<VOUT≤LVREF, where ΔV is being adjusted to where NFET 539 is on the edge of triggering. As shown in FIG. 6, as load current ILOAD increases, VOUT decreases and vice versa as the regulator adjusts VOUT to respond to the changing load current. In this voltage range of operation, ΔV rises and falls between 0 volts and ΔVmax relatively inversely with VOUT, and VG535 rises and falls between VG519 and VG519−ΔVmax inversely with ΔV. As VG535 rises and falls, the quiescent current through NFET 539 (I539) rises and falls slightly between 0 amps and IQ539 (the maximum quiescent current through NFET 539).

Right before time 601, the load current ILOAD rises due to an increase in load. In response, the voltage of VOUT drops to almost LVREF−ΔVmax. At time 601, the load current drops to 0 amps instantaneously such as in a power down event. In response, the voltage of VOUT begins to rise rapidly. Because ΔV is adjusted to bias PFET 535 such that NFET 539 is on the edge of triggering, NFET 539 is immediately made conductive such that the current through NFET 539 (I539) quickly rises to reduce the voltage of VOUT. Accordingly, the voltage of VOUT does not rise above LVREF, thereby preventing damage to the circuitry of the load. FIG. 6 has a dash line showing the voltage of VOUT if limiter circuit 511 were not present in regulator 501.

As shown in FIG. 6, ΔV does not drop as fast as the voltage of VOUT rises after time 601. This is due to the low pass filter of resister 525 and capacitor 533 preventing ΔV and VG535 from rapidly changing.

As shown in FIG. 6, LVREF and ΔVmax are set such that VOUT will always be above LVREF−ΔVmax during normal operation such that NFET 539 will be biased at the edge of triggering when VOUT is below LVREF during slow variations of load current. According, even if VOUT rises from a change in load condition (such as at time 601), NFET 539 will almost instantaneously turn on. However, in other embodiments, LVREF−ΔVmax may be set at a higher voltage with respect to at least some of the normal operating range of VOUT.

Referring back to FIG. 5, a voltage regulator may have other configurations in other embodiments. For example, output circuit 505 may be implemented with a PFET where the inverting input of buffer 504 would receive VTARGET and the feedback signal would be supplied to the noninverting input. In still other embodiments, regulator may be another type of voltage regulator such as a switching voltage regulator. In other embodiments, limiter circuit 511 may have other configurations and/or include other devices. For example, the comparison paths may be implemented NFETs or other types of transistors (e.g., bipolar transistors). Also, the TRIGGER signal may be provided to an intermediate transistor (not shown) that controls the gate of the shunt transistor. In still other embodiments, LVREF may be provided by other types of voltage reference sources. For example, LVREF can be provided from the voltage source that provides VTARGET where the current of current source 537 is higher than the current of current source 521 and PFETs 519 and 535 have the same W/L ratio, where PFETs 519 and 535 have a different W/L ratio, or a combination thereof. In other embodiments, resistor 525 may be replaced with other types of resistive circuits e.g., such as where a FET (not shown) is biased to operate in a linear region where the gate voltage controls the drain/source resistance.

As described herein, providing a voltage limiter circuit where the voltage differential between the control terminals of two transistor in two comparison paths can be adjusted based on a voltage of a node of one of the paths may provide for a limiter with faster shunt triggering. In such a configuration, the shunt transistor may be biased at the edge of triggering during normal operation. Such a trigger circuit may be more quickly turned on in response to an overvoltage condition.

Features described herein with respect to one embodiment may be implemented in other embodiments described herein. A source or a drain is a current terminal for a FET (field effect transistor). A gate is a control terminal for a FET. Two devices can be “coupled” to each other either through one or more other devices in a path or by being connected to each other. For example, referring to FIG. 5, the gates of PFETs 519 and 535 are coupled through resistor 525. The gate of PFET 535 is also coupled to capacitor 533 by being connected to it.

In one embodiment, a voltage regulator circuit includes an output configured to provide a regulated voltage, and a voltage limiter circuit coupled to the output. The voltage limiter circuit includes a first comparison path including a first transistor, the first comparison path coupled to receive a reference voltage, a second comparison path including a second transistor, the second comparison path coupled to the output, and a resistive circuit coupled in a path between a control terminal of the first transistor and a control terminal of the second transistor, where the resistive circuit provides a voltage drop across the resistive circuit for a voltage differential between the control terminal of the first transistor and the control terminal of the second transistor in response to a current flowing through the resistive circuit. The voltage limiter circuit includes a shunt transistor including a first current terminal coupled to the output and a second current terminal coupled to a supply voltage rail, when made conductive, the shunt transistor shunts current from the output to the supply voltage rail, a trigger node of the second comparison path, wherein a voltage of the trigger output node controls the conductivity of the shunt transistor, and a current control circuit for controlling a current through the resistive circuit to generate the voltage drop across the resistive circuit, wherein the current control circuit adjusts the current through the resistive circuit to control the voltage differential based on a voltage of the trigger node.

In a further embodiment of the voltage regulator circuit, assertion of a trigger signal from the trigger node to make the shunt transistor conductive reduces the current through the resistive circuit to reduce the voltage drop across the resistive circuit.

In a further embodiment of the voltage regulator circuit, the current control circuit further comprises a third transistor, wherein the conductivity of the third transistor is controlled by the voltage of the trigger node, the third transistor is made conductive to reduce current flowing through the resistive circuit when the shunt transistor is made conductive.

In a further embodiment of the voltage regulator circuit, the current generation circuit includes a current source, wherein the third transistor when conductive, conducts current from the current source to the voltage supply rail.

In a further embodiment of the voltage regulator circuit, the current generation circuit includes a fourth transistor coupled in a path with the resistive circuit for controlling current through the path including through the resistive circuit to control the voltage drop, wherein when the third transistor is made conductive to reduce the conductivity of the fourth transistor.

In a further embodiment of the voltage regulator circuit, the fourth transistor is implemented in a current mirror, the current mirror includes a fifth transistor in a current mirror configuration with the fourth transistor. The fourth transistor and the third transistor each include a current terminal coupled to a first terminal of a current source, wherein the fourth transistor and the fifth transistor each include a control terminal coupled to the first terminal of the current source.

In a further embodiment of the voltage regulator circuit, the shunt transistor is conductive when the voltage of the output is less than the reference voltage but higher than the reference voltage minus a maximum differential voltage between the control terminals of the first transistor and the second transistor. The shunt transistor is of a lesser conductivity when the voltage of the output is less than the reference voltage but higher than the reference voltage minus the maximum differential voltage than when the voltage of the output is at a higher voltage than the reference voltage.

In a further embodiment of the voltage regulator circuit, during an over voltage condition where the voltage of the output is higher than the reference voltage, the voltage drop across the resistive circuit is at a minimum value.

In a further embodiment of the voltage regulator circuit, voltage drop across the resistive circuit is at a maximum value when no current flows through the shunt transistor.

In a further embodiment of the voltage regulator circuit, the current control circuit further comprises a third transistor including a control terminal coupled to the trigger node, wherein the conductivity of the third transistor is made conductive to reduce current flowing through the resistive circuit when the shunt transistor is made conductive. The trigger node is coupled to a control terminal of the shunt transistor.

In a further embodiment of the voltage regulator circuit, the voltage limiter circuit further includes a capacitor, wherein the capacitor and the resistive circuit form a low pass filter for filtering changes to a voltage of the control terminal of the second transistor.

In a further embodiment of the voltage regulator circuit, the first and second transistors are characterized as PFET transistors.

In a further embodiment of the voltage regulator circuit, during normal operation, the current control circuit adjusts the voltage differential to keep the shunt transistor on an edge of triggering.

In another embodiment, a method for operating a voltage regulator includes providing a regulated voltage at an output. The method includes in a current limiter including a first comparison path that receives a reference voltage and a second comparison path coupled to the output, where the first comparison path includes a first transistor and the second comparison path includes a second transistor and a trigger node for controlling the conductivity of a shunt transistor to shunt current from the output to a voltage supply rail in response to an over voltage condition, adjusting a voltage differential between a control terminal of the first transistor and a control terminal of a second transistor based on a voltage of the trigger node.

In a further embodiment of the method, the voltage differential is at its maximum voltage when no current is flowing through the shunt transistor.

In a further embodiment of the method, the voltage differential is at its minimum voltage when the voltage of the output is higher than the reference voltage.

In a further embodiment of the method, the shunt transistor is conductive when the voltage of the output is less than the reference voltage but higher than the reference voltage minus a maximum differential voltage between the control terminals of the first transistor and the second transistor. The shunt transistor is of a lesser conductivity when the voltage of the output is less than the reference voltage but higher than the reference voltage minus the maximum differential voltage than when the voltage of the output is at a higher voltage than the reference voltage.

In a further embodiment of the method, the adjusting the voltage differential includes adjusting a current flowing through a resistive circuit located in a path between the control terminal of the first transistor and the control terminal of the second transistor.

In another embodiment, a voltage regulator circuit includes an output configured to provide a regulated voltage, and a voltage limiter circuit coupled to the output. The voltage limiter circuit includes a first comparison path including a first transistor, the first comparison path coupled to receive a reference voltage, a second comparison path including a second transistor, the second comparison path coupled to the output, a resistive circuit coupled in a path between a control terminal of the first transistor and a control terminal of the second transistor, where the resistive circuit provides a voltage drop across the resistive circuit for a voltage differential between the control terminal of the first transistor and the control terminal of the second transistor in response to a current flowing through the resistive circuit, a shunt transistor including a first current terminal coupled to the output and a second current terminal coupled to a supply voltage rail, when made conductive, the shunt transistor shunts current from the voltage output to the supply voltage rail, a trigger node of the second comparison path coupled to a control terminal of the shunt transistor, and a current control circuit for controlling a current through the resistive circuit to generate the voltage drop across the resistive circuit, The current control circuit adjusts the current through the resistive circuit to control the voltage differential based on a voltage of the trigger node.

In a further embodiment of the voltage regulator circuit, the current control circuit further comprises a third transistor including control terminal coupled to the trigger node, the third transistor is made conductive to reduce current flowing through the resistive circuit when the shunt transistor is made conductive.

While particular embodiments of the present invention have been shown and described, it will be recognized to those skilled in the art that, based upon the teachings herein, further changes and modifications may be made without departing from this invention and its broader aspects, and thus, the appended claims are to encompass within their scope all such changes and modifications as are within the true spirit and scope of this invention.

What is claimed is:

1. A voltage regulator circuit comprising:
an output configured to provide a regulated voltage;
a voltage limiter circuit coupled to the output, the voltage limiter circuit including:
a first comparison path including a first transistor, the first comparison path coupled to receive a reference voltage;
a second comparison path including a second transistor, the second comparison path coupled to the output;
a resistive circuit coupled in a path between a control terminal of the first transistor and a control terminal of the second transistor, where the resistive circuit provides a voltage drop across the resistive circuit for a voltage differential between the control terminal of the first transistor and the control terminal of the second transistor in response to a current flowing through the resistive circuit;
a shunt transistor including a first current terminal coupled to the output and a second current terminal coupled to a supply voltage rail, when made conductive, the shunt transistor shunts current from the output to the supply voltage rail;
a trigger node of the second comparison path, wherein a voltage of the trigger output node controls the conductivity of the shunt transistor;
a current control circuit for controlling a current through the resistive circuit to generate the voltage drop across the resistive circuit, wherein the current control circuit adjusts the current through the resistive circuit to control the voltage differential based on a voltage of the trigger node.

2. The voltage regulator circuit of claim 1 wherein assertion of a trigger signal from the trigger node to make the shunt transistor conductive reduces the current through the resistive circuit to reduce the voltage drop across the resistive circuit.

3. The voltage regulator circuit of claim 1 wherein the current control circuit further comprises a third transistor, wherein the conductivity of the third transistor is controlled by the voltage of the trigger node, the third transistor is made conductive to reduce current flowing through the resistive circuit when the shunt transistor is made conductive.

4. The voltage regulator circuit of claim 3 wherein the current generation circuit includes a current source, wherein the third transistor when conductive, conducts current from the current source to the voltage supply rail.

5. The voltage regulator circuit of claim 3 wherein the current generation circuit includes a fourth transistor coupled in a path with the resistive circuit for controlling current through the path including through the resistive circuit to control the voltage drop, wherein when the third transistor is made conductive to reduce the conductivity of the fourth transistor.

6. The voltage regulator circuit of claim 5 wherein:
the fourth transistor is implemented in a current mirror;
the current mirror includes a fifth transistor in a current mirror configuration with the fourth transistor, wherein the fourth transistor and the third transistor each include a current terminal coupled to a first terminal of a current source, wherein the fourth transistor and the fifth transistor each include a control terminal coupled to the first terminal of the current source.

7. The voltage regulator circuit of claim 1 wherein:
the shunt transistor is conductive when the voltage of the output is less than the reference voltage but higher than the reference voltage minus a maximum differential voltage between the control terminals of the first transistor and the second transistor;
the shunt transistor is of a lesser conductivity when the voltage of the output is less than the reference voltage but higher than the reference voltage minus the maximum differential voltage than when the voltage of the output is at a higher voltage than the reference voltage.

8. The voltage regulator circuit of claim 1 wherein during an over voltage condition where the voltage of the output is higher than the reference voltage, the voltage drop across the resistive circuit is at a minimum value.

9. The voltage regulator circuit of claim 1 wherein the voltage drop across the resistive circuit is at a maximum value when no current flows through the shunt transistor.

10. The voltage regulator circuit of claim 1 wherein:
the current control circuit further comprises a third transistor including a control terminal coupled to the trigger node, wherein the conductivity of the third transistor is made conductive to reduce current flowing through the resistive circuit when the shunt transistor is made conductive;
the trigger node is coupled to a control terminal of the shunt transistor.

11. The voltage regulator circuit of claim 1 wherein the voltage limiter circuit further includes a capacitor, wherein the capacitor and the resistive circuit form a low pass filter for filtering changes to a voltage of the control terminal of the second transistor.

12. The voltage regulator circuit of claim 1 wherein the first and second transistors are characterized as PFET transistors.

13. The voltage regulator circuit of claim 1, wherein during normal operation, the current control circuit adjusts the voltage differential to keep the shunt transistor on an edge of triggering.

14. A method for operating a voltage regulator comprising:
providing a regulated voltage at an output;
in a current limiter including a first comparison path that receives a reference voltage and a second comparison path coupled to the output, where the first comparison path includes a first transistor and the second comparison path includes a second transistor and a trigger node for controlling the conductivity of a shunt transistor to shunt current from the output to a voltage supply rail in response to an over voltage condition, adjusting a voltage differential between a control terminal of the first transistor and a control terminal of a second transistor based on a voltage of the trigger node.

15. The method of claim 14 wherein the voltage differential is at its maximum voltage when no current is flowing through the shunt transistor.

16. The method of claim 14 wherein the voltage differential is at its minimum voltage when the voltage of the output is higher than the reference voltage.

17. The method of claim 14 wherein:
the shunt transistor is conductive when the voltage of the output is less than the reference voltage but higher than the reference voltage minus a maximum differential voltage between the control terminals of the first transistor and the second transistor;
the shunt transistor is of a lesser conductivity when the voltage of the output is less than the reference voltage but higher than the reference voltage minus the maximum differential voltage than when the voltage of the output is at a higher voltage than the reference voltage.

18. The method of claim 14 wherein the adjusting the voltage differential includes adjusting a current flowing through a resistive circuit located in a path between the control terminal of the first transistor and the control terminal of the second transistor.

19. A voltage regulator circuit comprising:
an output configured to provide a regulated voltage;
a voltage limiter circuit coupled to the output, the voltage limiter circuit including:
a first comparison path including a first transistor, the first comparison path coupled to receive a reference voltage;
a second comparison path including a second transistor, the second comparison path coupled to the output;
a resistive circuit coupled in a path between a control terminal of the first transistor and a control terminal of the second transistor, where the resistive circuit provides a voltage drop across the resistive circuit for a voltage differential between the control terminal of the first transistor and the control terminal of the second transistor in response to a current flowing through the resistive circuit;
a shunt transistor including a first current terminal coupled to the output and a second current terminal coupled to a supply voltage rail, when made conductive, the shunt transistor shunts current from the voltage output to the supply voltage rail;
a trigger node of the second comparison path coupled to a control terminal of the shunt transistor;
a current control circuit for controlling a current through the resistive circuit to generate the voltage drop across the resistive circuit, wherein the current control circuit adjusts the current through the resistive circuit to control the voltage differential based on a voltage of the trigger node.

20. The voltage regulator circuit of claim 19 wherein the current control circuit further comprises a third transistor including control terminal coupled to the trigger node, the third transistor is made conductive to reduce current flowing through the resistive circuit when the shunt transistor is made conductive.
